(19) United States
(12) Patent Application Publication
(10) Pub. No.: US 2006/0046645 A1
(43) Pub. Date: Mar. 2, 2006

(54) Cell phones that communicate over a network of other cell phones as well as base stations

(76) Inventor: Scott A. Ogilvie, Lebanon, OR (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/927,567

(22) Filed: Aug. 25, 2004

(51) Int. Cl. H04B 1/00

(52) U.S. Cl. 455/11.1

(57) ABSTRACT

A method for a requesting cell phone includes (1) generating a request to communicate with a base station, (2) transmitting the request to a repeater cell phone, and (3) upon receiving a response to the request, transmitting data to the repeater phone for relay to the base station. A method for the repeater phone includes (1) upon receiving the request, appending its identifier in a repeater phone list in the request, (2) transmitting the request to the base station or another repeater phone, (4) upon receiving the response to the request, relaying the response to the requesting phone, and (5) relaying data between the requesting phone and the base station. A method for the base station includes (1) upon receiving the request, transmitting the response through the last repeater phone in the list and (2) communicating with the requesting phone through the repeater phones in the list.

### DESCRIPTION OF RELATED ART

In a typical cell phone system in the United States, the cell phone carrier chops up a coverage area (e.g., a city) into cells. Each cell is typically sized at about 10 square miles. Cells are normally thought of as hexagons on a big hexagonal grid. Each cell has a base station that consists of a tower and a small building containing the radio equipment.

Cell phones have low-power transmitters in them. The base station is also transmitting at low power. Low-power transmitters have two main advantages. First, the transmissions of a base station and the phones within its cell do not make it very far outside that cell. Therefore, the same frequencies can be reused extensively across the coverage area. Second, the power consumption of the cell phone, which is normally battery-operated, is relatively low. Low power means small batteries, which have made handheld cellular phones possible.

The cellular approach requires a large number of base stations in a coverage area of any size. A typical large city can have hundreds of towers. Each carrier also runs one central office called the Mobile Telephone Switching Office (MTSO). This office handles all of the phone connections to the normal land-based phone system, and controls all of the base stations in the region.

When a cell phone is first powered up, it listens for the control channel that cell phones and base stations use to talk to one another for call set-up and channel changing. If the phone cannot find any control channels to listen to, it knows it is out of range and displays a “no service” message.

The cell phone may transmit a registration request to the cell phone system on the control channel, and the MTSO keeps track of the cell phone's location in a database. This way, the MTSO knows which cell the cell phone is in when it wants to ring the cell phone. When the MTSO gets a call for a cell phone, it looks in its database to see which cell the cell phone is in. The MTSO picks a channel pair that the cell phone will use in that cell to take the call. The MTSO communicates with the cell phone over the control channel to tell it which frequencies to use, and once the cell phone and the tower switch on those frequencies, the call is connected.

As the cell phone moves toward the edge of a cell, the cell phone's base station notes that its signal strength is diminishing. Meanwhile, the base station in the cell that the cell phone is moving toward (which is listening and measuring signal strength on all frequencies) sees the cell phone's signal strength increasing. The two base stations coordinate with each other through the MTSO, and at some point, the cell phone gets a signal on the control channel telling it to change frequencies. This hand off switches the cell phone to the new cell.

As described above, cell phone coverage is currently limited by the placement of base stations. Thus, what is needed is a method to increase coverage areas to allow for temporary networks in case of emergencies.

### SUMMARY

In one embodiment of the invention, a method for a requesting cell phone to communicate with a base station through repeater cell phones includes (1) generating a request to communicate with a base station, (2) transmitting the request to a repeater cell phone, and (3) upon receiving a response from the base station, transmitting data to the repeater cell phone for relay to the base station.

In one embodiment of the invention, a method for a repeater cell phone to relay data between a requesting cell phone and a base station includes (1) upon receiving a request from the requesting cell phone to communicate with the base station, appending its identifier in a list of repeater cell phones in the request, (2) transmitting the request to the base station or another repeater cell phone, (3) upon receiving the response from the base station to the request, relaying the response to the requesting cell phone, and (5) relaying data between the requesting cell phone and the base station through repeater cell phones in the list.

In one embodiment of the invention, a method for a base station to communicate with a requesting cell phone through repeater cell phones includes (1) upon receiving a request from the requesting cell phone to communicate, transmitting a response through the last repeater cell phone in a list of repeater cell phones in the request and (2) communicating with the requesting cell phone through the repeater cell phones in the list.

### BRIEF DESCRIPTION OF THE DRAWINGS

FIG. 1 illustrates a network of repeater cell phones establishing a communication link between a base station and a cell phone outside the coverage area of the base station in one embodiment of the invention.

FIG. 2 illustrates another network of repeater cell phones establishing a communication link between a base station and a cell phone outside the coverage area of the base station in one embodiment of the invention.

FIG. 3 illustrates another network of repeater cell phones establishing a communication link between a base station and a cell phone outside the coverage area of the base station in one embodiment of the invention.

FIG. 4 is a flowchart of a method for a cell phone to communicate with a base station, which is located outside of the range of the cell phone, through repeater cell phones in one embodiment of the invention.

FIGS. 5, 6, 7, and 8 illustrate a request, a response, and messages between the cell phones and the base station in embodiments of the invention.

FIG. 9 is a flowchart of a method for a repeater cell phone to relay data between a base station and a cell phone outside the coverage area of the base station in one embodiment of the invention.

FIG. 10 is a flowchart of a method for a base station to communicate with a cell phone, which is located outside the coverage area of the base station, through repeater cell phones in one embodiment of the invention.

Use of the same reference numbers in different figures indicates similar or identical elements.

### DETAILED DESCRIPTION

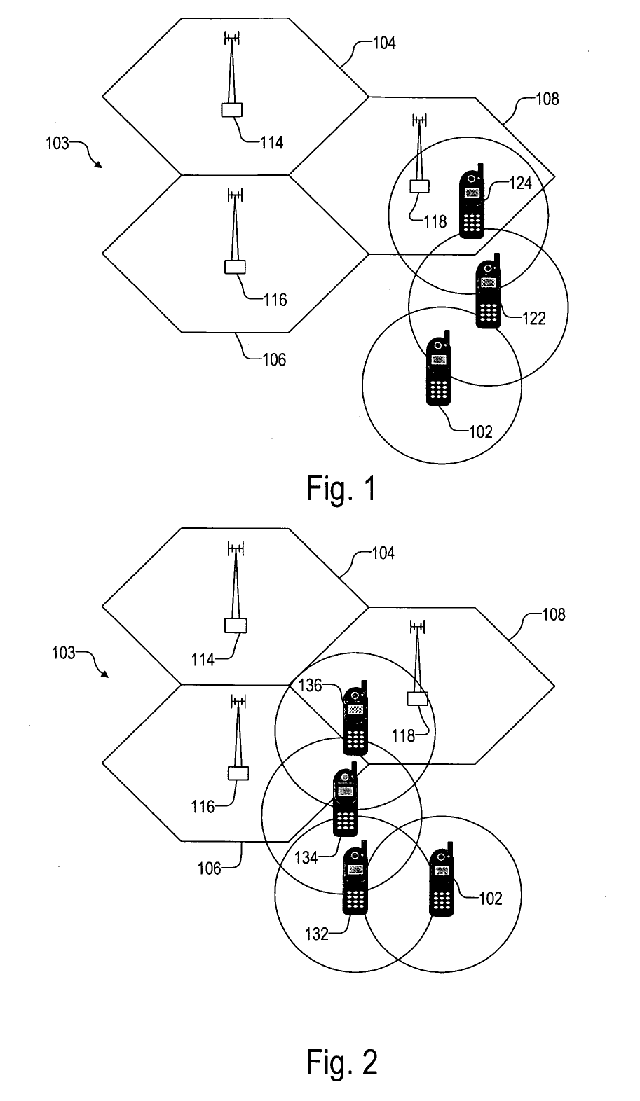

FIG. 1 illustrates a cell phone 102 that is outside the coverage area of a cell phone network 103. Cell phone network 103 includes cells 104, 106, and 108 having base stations 114, 116, and 118, respectively. For a number of reasons, such as a medical emergency in the wilderness, cell phone 102 needs to communicate with cell phone network 103. In one embodiment of the invention, cell phones 122 and 124 are used to establish a communication link between cell phone 102 and cell phone network 103 (e.g., base station 118). Note that the communication range of each cell phone is indicated by a circular perimeter around the cell phone. Similar to FIG. 1, FIG. 2 illustrates a separate but longer communication link established by cell phones 132, 134, and 136 between cell phone 102 and base station 118 in one embodiment of the invention. FIGS. 1 and 2 illustrate one scenario where base station 118 can establish multiple communication links to cell phone 102 through multiple groups of repeater cell phones. In one embodiment, base station 102 uses the communication link that is the shortest (e.g., having the fewest repeater cell phones).

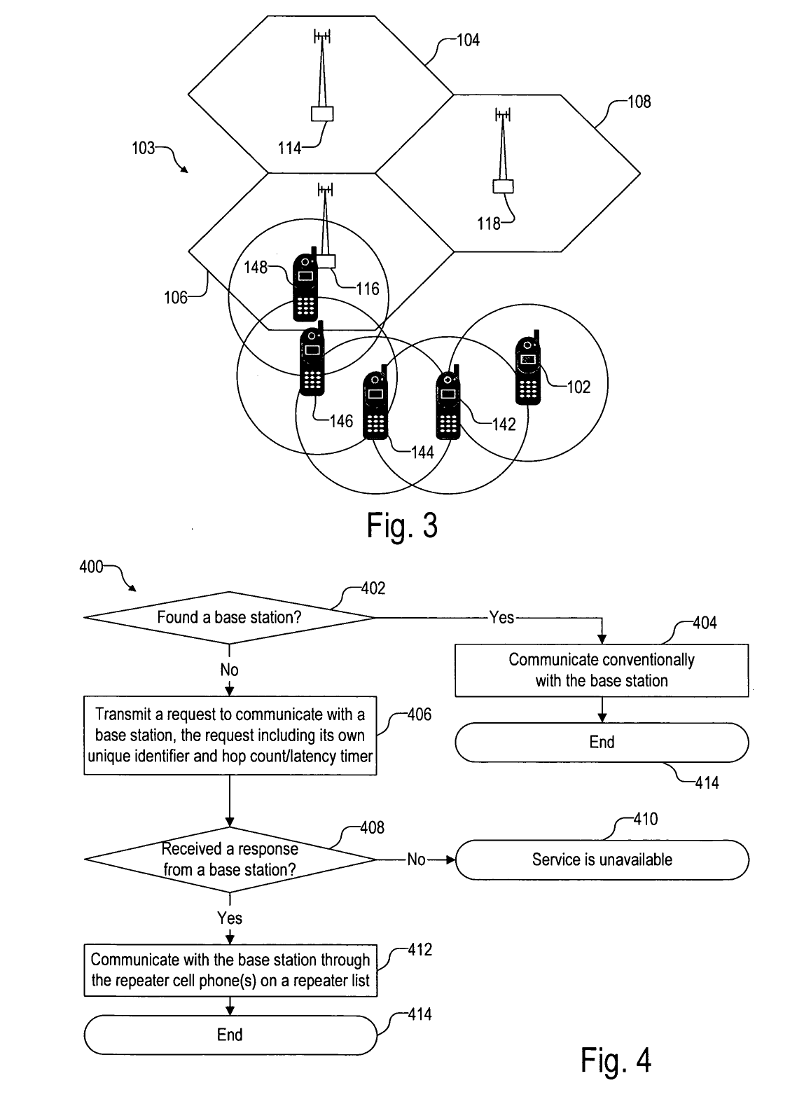

FIG. 3 illustrates another communication link between cell phone 102 and cell phone network 103 in one embodiment of the invention. Instead of base station 118, cell phone 102 is connected to base station 116 by cell phones 142, 144, 146, and 148. FIGS. 1 and 3 illustrate one scenario where multiple base stations (e.g., base stations 118 and 116) can establish communication links to cell phone 102. In one embodiment, each base station communicates to the Mobile Telephone Switching Office (MTSO) the number of cell phones in its communication link to cell phone 102, and the MTSO selects the base station with the shortest communication link to communicate with cell phone 102.

Hereafter, a “requesting cell phone” refers to any cell phone located outside the coverage area of a cell phone network which it wishes to communicate with, and a “repeater cell phone” refers to any cell phone that relays data between the requesting cell phone and a base station in the cell phone network. Methods for implementing the above described communication links are described hereafter in reference to FIGS. 1 to 3.

FIG. 4 is a flowchart of a method 400 for a requesting cell phone (e.g., cell phone 102 in FIGS. 1, 2, and 3) outside of the coverage area of a cell phone network (e.g., cell phone network 103) to communicate with the cell phone network in one embodiment of the invention. Method 400 may be implemented in a cell phone with software, hardware, or a combination thereof.

In step 402, requesting cell phone 102 listens on the control channel for an available base station in cell phone network 103. If requesting cell phone 102 finds a base station (e.g., base station 118 in FIGS. 1, 2, and 3), then step 402 is followed by step 404. Otherwise step 402 is followed by step 406.

In step 404, requesting cell phone 102 communicates conventionally with base station 118. Step 404 is followed by step 414, which ends method 400.

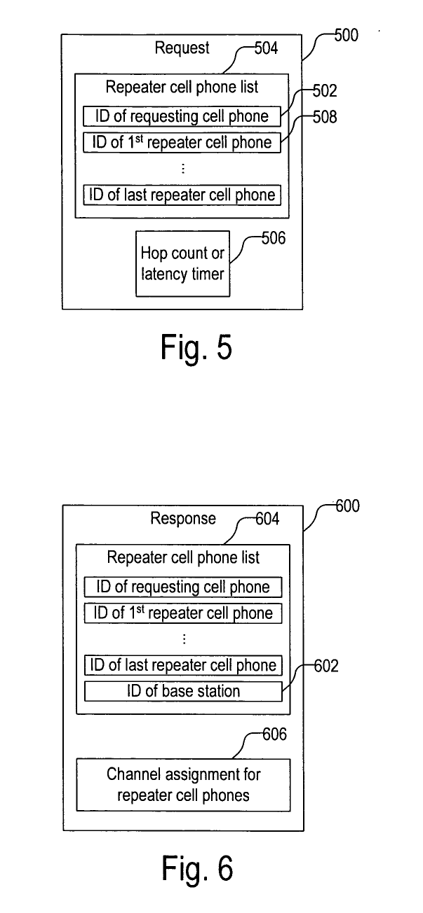

In step 406, requesting cell phone 102 transmits a request 500 (FIG. 5) to repeater cell phones in its vicinity to establish a communication link with cell phone network 103. Request 500 includes a unique identifier 502 of requesting cell phone 102 in a repeater cell phone list 504. Repeater cell phone list 504 tracks the unique identifiers of repeater cell phones that have relayed request 500 to another repeater cell phone or a base station. This list is a roadmap to the repeater cell phones that would make up the communication link between the requesting cell phone and the base station. In one embodiment, request 500 further includes a hop count or a latency timer 506. The hop count tracks the number of repeater cell phones that have relayed request 500 to another repeater cell phone. Latency timer tracks the time that it has taken for request 500 to be relayed through the repeater cell phones. In one embodiment, requesting cell phone 102 transmits request 500 in the control channel that all cell phones monitor. Step 406 is followed by step 408.

In step 408, requesting cell phone 102 listens for a response 600 (FIG. 6) from a base station (e.g., base station 118) in cell phone network 103. If requesting cell phone 102 does not receive response 600 before timing out, then step 408 is followed by step 410. If requesting cell phone 102 receives response 600 before timing out, then step 408 is followed by step 412.

Response 600 would be relayed by a repeater cell phone over the control channel to requesting cell phone 102. Response 600 includes a unique identifier 602 of base station 118 in a repeater cell phone list 604. Repeater cell phone list 604 includes the unique identifiers of the repeater cell phones that form the communication link between base station 118 and requesting cell phone 102.

Response 600 further includes channel assignment list 606 for the cell phones in list 604. Channel assignment can be performed by base station 118 or the MTSO. If the geographical location of each cell phone in list 604 is unknown, then the number of cell phones in the communication link between requesting cell phone 102 and base station 118 is limited. This is because the cell phone channels would not be reused in fear of interference with other cell phones in the vicinity. However, if the geographic location of each cell phone in list 604 is known through the use of GPS or signal strength triangulation built into the phone, then the cell phone channels can be reused to increase the number of cell phones that can be supported. In such an embodiment, each cell phone would append its geographic location in request 500.

In step 410, requesting cell phone 102 indicates to the user that emergency cell phone service is not available and ends method 400.

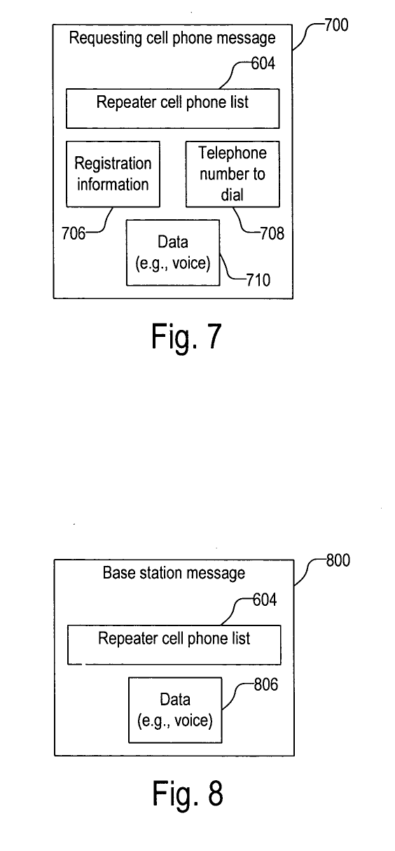

In step 412, requesting cell phone 102 communicates with base station 118 through the repeater cell phones in list 604 (FIG. 6). Requesting cell phone 102 does this by transmitting a message 700 (FIG. 7) to the first repeater cell phone in list 604. Message 700 includes repeater cell phone list 604, information 706 for registering with cell phone network 103, a telephone number 708 to be dialed, and data 710 (e.g., voice to be communicated to the person at telephone number 708).

After registering with cell phone network 103, requesting cell phone 102 can transmit messages 700 with only repeater cell phone list 604 and data 710. Requesting cell phone 102 also receives messages 800 (FIG. 8) from base station 118. Message 800 includes repeater cell phone list 604 and data 806 (e.g., voice data from the person at telephone number 708 to the user of requesting cell phone 102). Step 412 is followed by step 414, which ends method 400.

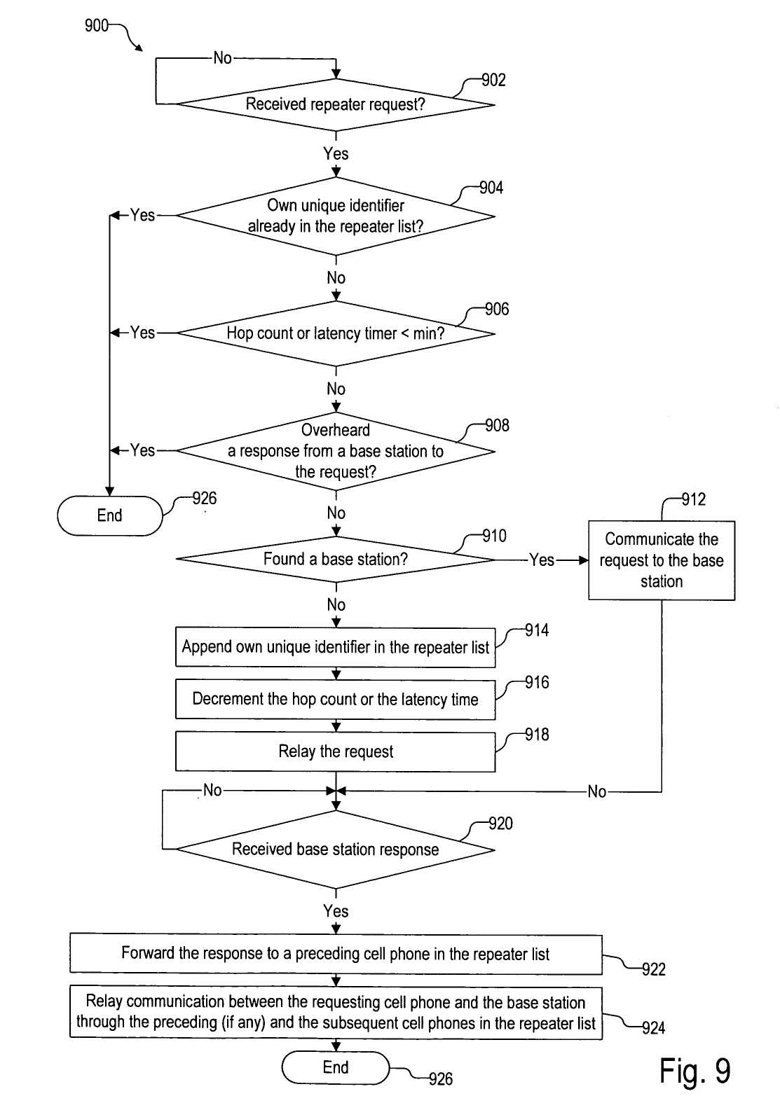

FIG. 9 is a flowchart of a method 900 for a repeater cell phone (e.g., cell phone 122 in FIG. 1) to establish a communication link between a requesting cell phone (e.g., cell phone 102) and a cell phone network (e.g., cell phone network 103) in one embodiment of the invention. Method 900 may be implemented in a cell phone with software, hardware, or a combination thereof.

In step 902, repeater cell phone 122 listens for request 500 (FIG. 5) from cell phone 102 to communicate with cell phone network 103. As described above, requesting cell phone 102 can transmits request 500 in the control channel that all cell phones monitor. If repeater cell phone 122 receives request 500, then step 902 is followed by step 904. Otherwise repeater cell phone 122 continues to listen for request 500.

In step 904, repeater cell phone 122 determines if its own unique identifier is already in repeater cell phone list 504 (FIG. 5) in request 500. This occurs when repeater cell phone 122 has previously relayed request 500 and that request 500 has been unable to reach cell phone network 103 and has somehow been relayed back to repeater cell phone 122. If so, step 904 is followed by step 926, which ends method 900. If repeater cell phone 122 does not find its own unique identifier in list 504, then step 904 is followed by step 906.

In step 906, repeater cell phone 122 determines if hop count/latency timer 506 (FIG. 5) in request 500 is less than a minimum threshold (e.g., 0). As will be described later, hop count/latency timer 506 is decremented each time request 500 is relayed by a repeater cell phone. This ensures a good communication link can be established between requesting cell phone 102 and cell phone network 103 as long as hop count/latency timer 506 is greater than the minimum threshold. If hop count/latency timer 506 is less then the minimum threshold, then step 906 is followed by step 926, which ends method 900. Otherwise step 906 is followed by step 908.

In step 908, repeater cell phone 122 determines if it has already overhead a response 600 (FIG. 6) from a base station (e.g., base station 118) to requesting cell phone 102. As all cell phones monitor the control channel, repeater cell phone 122 would know if base station 118 has already responded to request 500 (FIG. 5) by transmitting response 600 over the control channel. If repeater cell phone 122 has already overheard response 600, then step 908 is followed by step 926, which ends method 900. Otherwise step 908 is followed by step 910.

In step 910, repeater cell phone 122 listens for an available base station in cell phone network 103. If requesting cell phone 102 finds a base station (e.g., base station 118 in FIG. 1), then step 910 is followed by step 912. Otherwise step 910 is followed by step 914.

In step 912, repeater cell phone 122 transmits request 500 (FIG. 5) to base station 118. In one embodiment, repeater cell phone 122 conventionally transmits request 500 to base station 118 over the control channel. Step 912 is followed by step 920.

In step 914, repeater cell phone 122 appends its own unique identifier 508 (FIG. 5) in repeater cell phone list 504. Step 914 is followed by step 916.

In step 916, repeater cell phone 122 decrements hop count/latency timer 506. Step 916 is followed by step 918.

In step 918, repeater cell phone 122 relays request 500 to another repeater cell phone, if any. Step 918 is followed by step 920.

In step 920, repeater cell phone 122 listens for response 600 (FIG. 6) from base station 118. If repeater cell phone 122 receives response 600, then step 920 is followed by step 922. Otherwise repeater cell phone 122 continues to listen for response 600.

In step 922, repeater cell phone 122 relays response 600 (FIG. 6) to a preceding cell phone in repeater cell phone list 604. The preceding cell phone could be another repeater cell phone or the requesting cell phone itself. Step 922 is followed by step 924.

In step 924, repeater cell phone 122 relays messages between base station 118 and requesting cell phone 102. Specifically, repeater cell phone 122 relays messages 700 (FIG. 7) received from a preceding cell phone to a subsequent cell phone in list 604, and messages 800 (FIG. 8) received from the subsequent cell phone to the preceding cell phone in list 604. As described before, repeater cell phones 122 would use the assigned channel specified in channel assignment 606 to communicate with the subsequent and preceding cell phones. Step 924 is followed by step 926, which ends method 900.

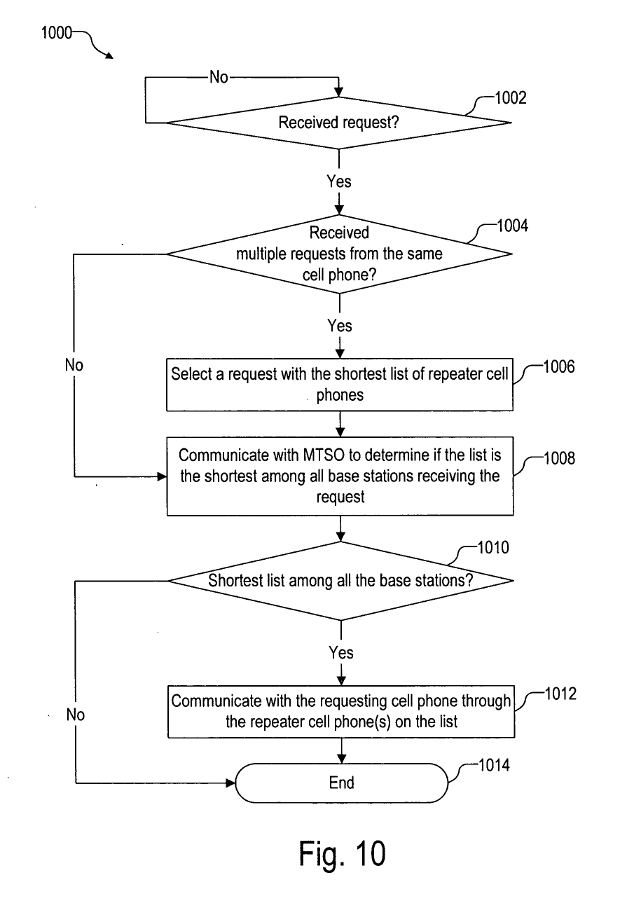

FIG. 10 is a flowchart of a method 1000 for a base station (e.g., base station 118 in FIGS. 1, 2, and 3) to communicate with a requesting cell phone (e.g., cell phone 102) through a communication link established through repeater cell phones in one embodiment of the invention. Method 1000 may be implemented in base station radio equipment with software, hardware, or a combination thereof.

In step 1002, base station 118 listens for request 500 (FIG. 5) from requesting cell phone 102. As described above, a repeater cell phone can relay request 500 in the control channel that base station 118 monitors. If base station 118 receives request 500, then step 1002 is followed by step 1004. Otherwise base station 118 continues to listen for request 500.

In step 1004, base station 118 determines if it has received multiple requests 500 (FIG. 5) from requesting cell phone 102. This can occur when request 500 gets relayed by different group of repeater cell phones to the same base station. For example, FIG. 1 shows that repeater cell phones 122 and 124 establish one communication link while FIG. 2 shows the repeater cell phones 132, 134, and 136 establish another communication link. Thus, base station 118 can receive multiple requests 500 having different repeater cell phone lists 504. If so, then step 1004 is followed by step 1006. Otherwise step 1004 is followed by step 1008.

In step 1006, base station 118 selects a request 500 (FIG. 5) having the shortest repeater cell phone list 504. This allows for the most efficient communication link between base station 118 and requesting cell phone 102. Step 1006 is followed by step 1008.

In step 1008, base station 118 communicates to the MTSO the shortest repeater cell phone list 504 (FIG. 5) in order to determine it if has the shortest repeater cell phone list 504 among all the base stations that have received request 500. This occurs when request 500 gets relayed by different groups of repeater cell phones to different base stations. For example, FIG. 1 shows that repeater cell phones 122 and 124 establish one communication link between base station 118 and requesting cell phone 102 while FIG. 3 shows the repeater cell phones 142, 144, 146, and 148 establish another communication link between base station 116 and requesting cell phone 102. Step 1008 is followed by step 1010.

In step 1010, base station 118 determines if it has the shortest repeater cell phone list 504 (FIG. 5) among all the base stations that have received request 500. The MTSO can determine this by simply comparing all the lists 504 that it receives and informing the result to the base stations. If base station 118 has the shortest list 504, then step 1010 is followed by step 1012. Otherwise step 1010 is followed by step 1014, which ends method 1000.

In step 1012, base station 118 transmits response 600 (FIG. 6) to the last repeater cell phone on list 604 in order to establish the communication link with requesting cell phone 102. List 604 is the same as list 504 in request 500 once request 500 reaches base station 118. Thereafter, base station 118 transmits messages 800 (FIG. 8) to requesting cell phone 102 through the repeater cell phones on list 604. Messages 800 includes repeater cell phone list 604 and data 806 (e.g., voice data to the user of requesting cell phone 102). Base station 118 also receives messages 700 (FIG. 7) from requesting cell phone 102.

Various other adaptations and combinations of features of the embodiments disclosed are within the scope of the invention. For example, messages 700 and 800 may not include repeater cell phone list 604 if each repeater cell phones remembers the assigned channels when it relays response 600 and continues to use the assigned channels until instructed otherwise by the base station. Numerous embodiments are encompassed by the following claims.

What is claimed is:

1. A method for a requesting cell phone to communicate with a base station when the requesting cell phone is outside a coverage area of the base station, comprising:
generating a request to communicate with the base station, the request comprising an identifier of the requesting cell phone;
transmitting the request to a repeater cell phone;
listening for a response from the base station relayed through the repeater cell phone; and
upon receiving the response, transmitting data to the repeater cell phone for the repeater cell phone to relay to the base station.

2. The method of claim 1, wherein the request further comprises a hop count tracking a number of repeater cell phones that have relayed the request to the base station.

3. The method of claim 1, wherein the request further comprises a latency timer tracking a time that has been taken by repeater cell phones to relay the request to the base station.

4. The method of claim 1, wherein said transmitting the request and listening to the repeater cell phone occur on a control channel.

5. The method of claim 1, further comprising receiving data from the base station relayed through the repeater cell phone.

6. The method of claim 5, wherein said transmitting data to the repeater cell phone and receiving data through the repeater cell phone occur on channels designated in the response.

7. A method for a repeater cell phone to relay data between a requesting cell phone and a base station when the requesting cell phone is outside a coverage area of the base station, comprising:
listening for a request comprising an identifier of a requesting cell phone that wishes to communicate with the base station;
upon receiving the request, appending an identifier of the repeater cell phone in a list of repeater cell phones;
determining when the repeater cell phone is within the coverage area of the base station;
when the repeater cell phone is in the coverage area of the base station, transmitting the request to the base station; and
when the repeater cell phone is not in the coverage area of the base station, transmitting the request to another repeater cell phone.

8. The method of claim 7, further comprising:
determining when the identifier of the repeater cell phone is already in the list of repeater cell phones; and
terminating the method when the identifier of the repeater cell phone is already in the list of repeater cell phones.

9. The method of claim 8, further comprising:
determining when the repeater cell phone has already heard a response from the base station to the request; and
terminating the method when the repeater cell phone has already heard the response from the base station to the request.

10. The method of claim 9, wherein the request further comprises at least one of (1) a hop count tracking a number of repeater cell phones that have relayed the request to the base station and (2) a latency timer tracking a time that has been taken by the repeater cell phones to relay the request to the base station, the method further comprises:
determining when said at least one of the hop count and the latency timer is less than a threshold;
decrementing said at least one of the hop count and the latency timer when said at least one of the hop count and the latency timer is not less than the threshold; and
terminating the method when said at least one of the hop count and the latency timer is less than the threshold.

11. The method of claim 7, wherein said listening for a request and said transmitting the request occur on a control channel.

12. The method of claim 7, further comprising, after said transmitting the request:
listening for a response to the request from the base station, the response being relayed from a subsequent repeater cell phone in another list of repeater cell phones in the response;
transmitting the response to a preceding repeater cell phone in said another list of repeater cell phones in the response; and
relaying the data between the requesting cell phone and the base station through the preceding and the subsequent repeater cell phones.

13. The method of claim 12, wherein said relaying the data occurs on channels designated in the response.

14. A method for a base station to communicate with a requesting cell phone outside of a coverage area of the base station, comprising:
listening for a first request from the requesting cell phone to communicate with the base station, the first request comprising an identifier of the requesting cell phone and a first list of repeater cell phones that have relayed the request to the base station; and
transmitting a response to the request through a last repeater cell phone in a second list of repeater cell phones included in the response.

15. The method of claim 14, further comprising, prior to said transmitting a response:
comparing the first list to a third list of repeater cell phones in another request from the requesting cell phone; and
selecting one of the first list and the third list as the second list in the response.

16. The method of claim 14, further comprising, prior to said transmitting a response:
determining when the first list is the shortest list compared to a plurality of lists of repeater cell phones in a plurality of requests received by other base stations, wherein said transmitting a response occurs only when the first list is the shortest list and the second list comprises the first list.

17. The method of claim 16, wherein said determining when the first list is the shortest list comprises:
transmitting a number of repeater cell phones in the first list to a mobile telephone switching office (MTSO); and
receiving an indication from the MTSO that the first list is the shortest list.

18. The method of claim 14, further comprising communicating data with the requesting cell phone through the last repeater cell phones in the second list.

19. The method of claim 18, further comprising:
assigning channels to be used by the requesting cell phone and the repeater cell phones in the first list; and
including channel assignments in the response.

20. The method of claim 19, further comprising:
receiving, from a MTSO, the channel assignments to the requesting cell phone and the repeater cell phones in the second list.
